(19) United States
(12) Patent Application Publication
(10) Pub. No.: US 2012/0229292 A1
(43) Pub. Date: Sep. 13, 2012

(54) LIGHTING APPARATUS FOR A BEACON SYSTEM

(75) Inventors: Holger Laabs, Berlin (DE); Rainer Seidel, Berlin (DE)

(73) Assignee: OSRAM AG, Munich (DE)

(21) Appl. No.: 13/513,222

(22) PCT Filed: Nov. 16, 2010
(86) PCT No.: PCT/EP2010/067585

§ 371 Date: Jun. 1, 2012

(30) Foreign Application Priority Data
Dec. 2, 2009 (DE) 10 2009 047 402.1

(51) Int. Cl. G08B 5/36

(52) U.S. Cl. 340/815.45

(57) ABSTRACT

A lighting apparatus for a beacon system may include a first light source having at least one visible light emitting diode; and a second light source configured to essentially emit infrared radiation.

### TECHNICAL AREA

The invention is based on a lighting apparatus for a beacon system.

### PRIOR ART

For orientation and guidance of aircraft which are on approach to an airport or the like or are moving on its takeoff, landing or apron runways, light signals are emitted by beacon systems of the airport. The beacon systems include all technical lighting aids designed to guarantee safe flight operations and safe movement of aircraft in the area of an airport even in darkness and/or conditions of poor visibility. Usual beacon systems have lighting means with halogen lamps (e.g. GB 1270658A or EP 0 653 351 B1). The halogen lamps also emit infrared radiation in addition to visible light, which is used as a signal generator for electronic landing aids of aircraft in bad visibility, as a result of fog or rain for example (e.g. WO 2009/128065 A1). However, the humid atmosphere absorbs a large proportion of the emitted infrared radiation (absorption spectrum of water molecules), so that this part of the radiation is no longer available for the useful effect (infrared orientation aid). Only infrared light in specific areas of the spectrum (so-called spectral transmission window) can be emitted over a longer distance through the humid air—and is then able to be detected with the aid of infrared cameras of the aircraft for positioning purposes. FIG. 6 shows the spectral transmission of the atmosphere for electromagnetic radiation in the range of approximately 0.9 μm to 2.7 μm

(source: http://www.gemini.edu/node?q=node/10789).

The wavelength range is with a transmission close to 1 of the said spectral transmission windows. These include for example especially wavelengths ranging between approximately 1 μm and 1.1 μm, 1.2 μm and 1.3 μm, 1.5 μm and 1.75 μm or 2.1 μm and 2.3 μm.

The disadvantage of such beacon systems is the high energy requirement for generating the infrared radiation outside the spectral transmission window, the very short life of the halogen lamps and the associated expensive maintenance work for replacing the halogen lamps.

### SUMMARY OF THE INVENTION

The object of the present invention is to create a lighting apparatus having a low energy requirement and a long life.

This object is achieved by a lighting apparatus with the features of claim 1.

According to the invention a lighting apparatus for a beacon system has at least one first light source featuring at least one VIS-LED (VISIBLE-LED) and a second light source essentially emitting infrared radiation. The term VIS-LED is to be understood as meaning light emitting diodes (LED) which are designed to emit electromagnetic radiation visible to the human eye, i.e. white or colored light.

The advantage of this solution is that visible (white or colored) light, for orientation and guidance of aircraft which are on the approach to an airport for example, can be provided by the light sources having at least one LED. The LEDs, by comparison with the prior art explained above, have a longer life and a lower energy requirement. The infrared radiation used for orientation in conditions of poor visibility is then emitted via a further light source which only has to provide this radiation and can thus be specifically adapted for the purpose. Furthermore the energy for supplying the infrared light source can be saved in good weather.

An especially advantageous embodiment can be found in the dependent claims.

Advantageously the light source emitting the infrared radiation is an infrared laser, an infrared LED and/or a halogen lamp essentially emitting light in the infrared area of the spectrum. In the event of an infrared laser or an infrared LED being used, an IR wavelength is preferably explicitly selected, which lies in a spectral transmission window of the atmosphere. Wavelengths ranging between approximately 1 μm and 1.1 μm, 1.2 μm and 1.3 μm, 1.5 μm and 1.75 μm or 2.1 μm and 2.3 μm are suitable for this purpose.

Preferably the light sources are accommodated in a common heat-dissipating housing. The lighting apparatus thus forms one unit, with a plurality of units then being able to be arranged on a runway of an airport. The heat-dissipating properties of the housing enable further cooling elements to be dispensed with.

To increase the luminous intensity of the lighting apparatus a plurality of first and/or second light sources can be disposed in the housing.

Advantageously the first light source is at least a conventional and low-cost LED module with four LEDs, to which one reflector is assigned in each case.

In a further embodiment the first light source is designed as a compact multichip LED.

It is also conceivable to design the first light source as an LED submount occupying an extremely small space.

In a further embodiment of the invention a plurality of LED modules, multichip LEDs and/or LEDs submounts are disposed roughly concentrically around the second light source.

The lighting apparatus is especially suited for use as a landing beacon for aircraft on approach to an airport, as an obstacle beacon or runway beacon or as a beacon light in marine navigation.

### BRIEF DESCRIPTION OF THE DRAWINGS

The invention will be explained in greater detail below with reference to the exemplary embodiments. The figures show:

FIG. 1 a perspective diagram of a lighting apparatus in accordance with a first exemplary embodiment;

FIG. 2 a perspective diagram of the lighting apparatus in accordance with a second exemplary embodiment;

FIG. 3 a perspective diagram of the lighting apparatus in accordance with a third exemplary embodiment;

FIG. 4 a perspective diagram of the lighting apparatus in accordance with a fourth exemplary embodiment;

FIG. 5 a perspective diagram of the lighting apparatus in accordance with a fifth exemplary embodiment;

FIG. 6 a section of the spectral transmission of the atmosphere for electromagnetic radiation.

### PREFERRED EMBODIMENT OF THE INVENTION

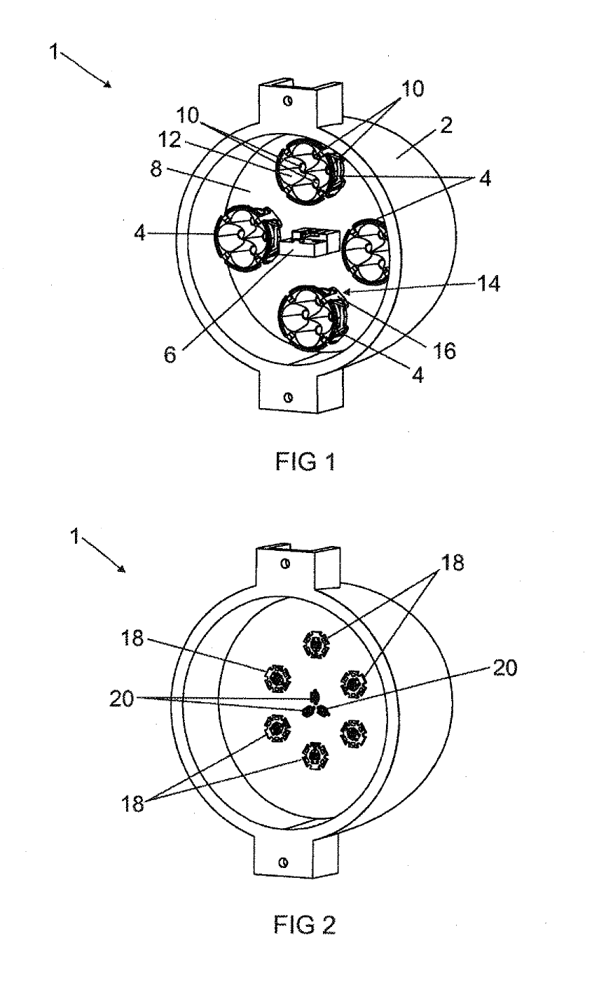

FIG. 1 shows a perspective diagram of a lighting apparatus 1 in accordance with a first exemplary embodiment. This has four roughly concentric LED modules 4 arranged in a bowl-shaped housing 2 and an infrared laser 6 (IR laser) disposed approximately in the center of the LED modules 4. These types of lighting apparatus 1 are used for example in standard approach beacon or runway beacon systems of airports. The LED modules 4 in such cases essentially emit white or colored light, which serves as a landing aid for aircraft in conditions of good visibility. In conditions of poor visibility, because of fog or rain for example, infrared radiation emitted by the IR laser 6 is received by an infrared camera disposed on an aircraft for positioning on the approach or runway beacon systems.

The LED modules 4 and the IR laser 6 are characterized, unlike the halogen lamps in the prior art described at the start, by low energy consumption and a long life.

The LED modules 4 and the IR laser 6 are attached and electrically contacted on a printed circuit board 8 disposed on the base side of the housing 2. The printed circuit board 8 involves an FR4 board with a metal core for increased heat dissipation. The housing 2 serving as a heat sink likewise consists of heat-dissipating materials. Each LED module 4 has four LEDs 10, to each of which is assigned a roughly funnel-shaped reflector 12. Its longitudinal axis extends roughly orthogonally to the board 8 and its diameter increases in the direction of emission of the LEDs 10. The reflectors 12 of an LED module 4 are embodied in one piece and attached together with the LEDs 10 via a clip connection 14 to the printed circuit board 8. The clip connection 14 has four arms 16 extending away from the printed circuit board 8, which are arranged evenly around the reflectors 12 embodied in one piece and grip the reflector 12 for support with an end section away from the printed circuit board 8. The clip connection 14 enables the LEDs 10 to be replaced easily.

The LED modules 4 are disposed roughly concentrically and evenly on the printed circuit board 8 around the IR laser 6 which is then located roughly in the middle of the LED modules 4.

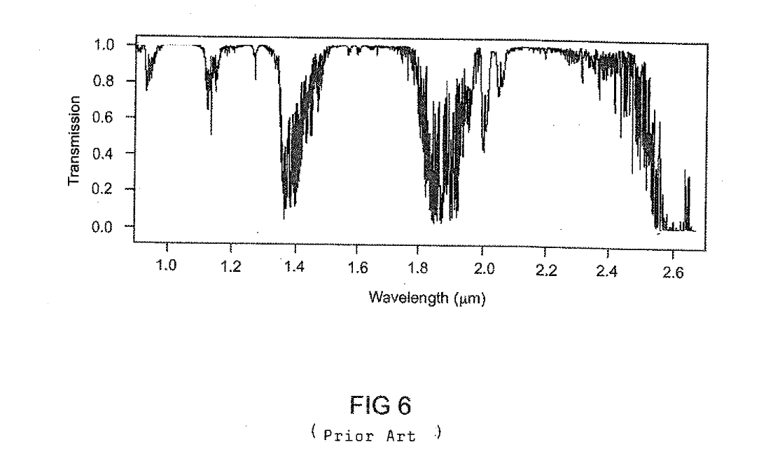

The IR laser 6 typically involves a conventional High Power Single Mode InP Laser, which emits at a wavelength of e.g. 1250 or 1750 nm. These wavelengths lie in a spectral transmission window of the atmosphere and consequently the transmission is almost 1 (cf. FIG. 6), i.e. the transmission losses are accordingly very small.

FIG. 2 shows a perspective view of the lighting apparatus 1 in accordance with a second exemplary embodiment. Instead of four LED modules 4 as in FIG. 1, this has eight multichip LEDs 18. These are for example of type “Ostar” made by Osram. These types of multichip LEDs 18 are disclosed in DE 10 2008 033 910 A1.

In the second exemplary embodiment the IR semiconductor laser 6 from FIG. 1 is also replaced by three infrared LEDs 20 (IR LEDs) arranged in a star shape. The multichip LEDs 18 are disposed spaced around the IR LEDs 20 and at an equal distance from one another—as in FIG. 1.

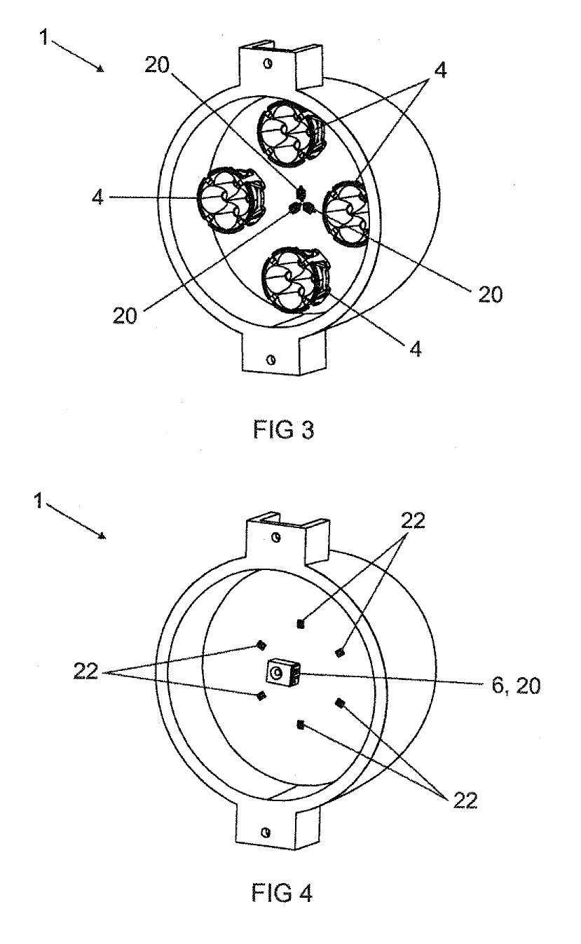

A perspective diagram of an exemplary embodiment of the lighting apparatus 1 depicted in FIG. 3 shows a combination of the first and second exemplary embodiments from FIGS. 1 and 2. The four LED modules 4 from FIG. 1 are used to emit white or colored light, the IR LEDs 20 from FIG. 2 are used to emit infrared radiation.

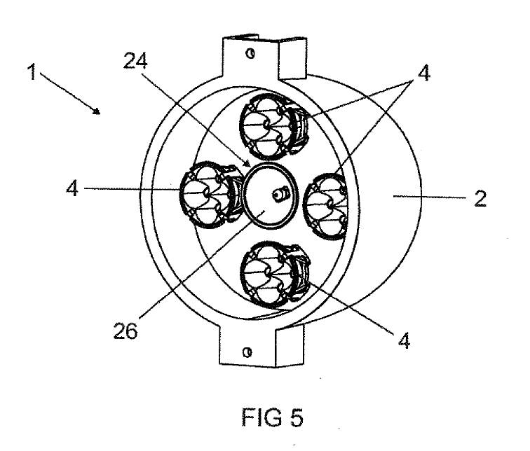

FIG. 4 shows the lighting apparatus 1 in a perspective diagram in accordance with the fourth exemplary embodiment. Instead of LED modules 4 as in FIG. 3, six LED submounts 22 are used. The LED submounts 22 involve a plurality of individual LEDs—for example eight—which are mounted electrically in parallel on a bar or submount. Such an LED submount 22 is characterized by an extremely small size. An IR laser 6 or an IR LED 20 is again arranged in the middle of the LED submounts 22.

Shown in FIG. 5 is the lighting apparatus 1 in a perspective diagram in accordance with a fifth exemplary embodiment. Unlike the first exemplary embodiment 1 from FIG. 1, a halogen lamp 24 with a reflector 26 is used instead of the IR laser in the middle of the LED modules 4 in the housing 2. LED technology is thus combined with halogen technology. By dimming the halogen lamp 24 the maximum of a wavelength spectrum is able to be shifted into the infrared spectral area, in order to adapt the halogen lamp 24 to the spectral transmission window of the atmosphere explained at the start in the prior art. The dimming advantageously gives the halogen lamp 24 a longer life.

It is conceivable for the light source emitting the infrared radiation to only be switched on if required, for example under conditions of poor visibility.

As well as the combinations of the first light sources 4, 18, 22 and second light sources 6, 20, 24 from FIGS. 1 to 5 further combinations are entirely possible. Thus the halogen and 24 could for example serve as a replacement for the second light source in FIG. 2, 3 or 4. Different first and different second light sources 4, 6, 18, 20, 22, 24 could also be used for each lighting apparatus 1.

A lighting apparatus for a beacon system is disclosed, having at least one VIS-LED as its first light source and a second light source essentially emitting infrared radiation.

1. A lighting apparatus for a beacon system, comprising:
a first light source having at least one visible light emitting diode; and
a second light source configured to essentially emit infrared radiation.

2. The lighting apparatus as claimed in claim 1, wherein the second light source is a light source selected from a group consisting of:
an infrared laser;
an infrared light emitting diode; and
a halogen lamp.

3. The lighting apparatus as claimed in claim 2, wherein the infrared laser, or the infrared light emitting diode is configured to emit with a wavelength which lies in a spectral transmission window of the atmosphere.

4. The lighting apparatus as claimed in claim 3, wherein the wavelength lies in the range of between approximately 1 μm and 1.1 μ.

5. The lighting apparatus as claimed in claim 1,
wherein the light sources are accommodated in a common heat-dissipating housing.

6. The lighting apparatus as claimed in claim 1,
wherein a at least one of a plurality of first light sources and second light sources are disposed in the housing.

7. The lighting apparatus as claimed in claim 1,
wherein the at least one first light source is light emitting diode module with four light emitting diodes in each case, to each of which a reflector is assigned.

8. The lighting apparatus as claimed in claim 1,
wherein the at least one first light source being a multichip light emitting diode.

9. The lighting apparatus as claimed in claim 1,
wherein the at least one first light source is at least one light emitting diode submount.

10. The lighting apparatus as claimed in claim 1,
wherein a plurality of first light sources are being disposed roughly concentrically around the second light source.

11. The lighting apparatus as claimed in claim 1,
wherein said apparatus is used as a system selected from a group consisting of: an approach beacon system for aircraft approaching an airport; an obstacle beacon system; and a landing runway beacon system.

12. The lighting apparatus as claimed in claim 1,
wherein said apparatus is used as a beacon light in marine navigation.

13. The lighting apparatus as claimed in claim 3,
wherein the wavelength lies in the range of between approximately 1.2 μm and 1.3 μm.

14. The lighting apparatus as claimed in claim 3,
wherein the wavelength lies in the range of between approximately 1.5 μm and 1.75 μm.

15. The lighting apparatus as claimed in claim 3,
wherein the wavelength lies in the range of between approximately 2.1 μm and 2.3 μm.
